(19) United States
(12) Patent Application Publication
(10) Pub. No.: US 2006/0190395 A1
(43) Pub. Date: Aug. 24, 2006

(54) Method for entity risk management and accumulating assets for a secure retirement

(75) Inventor: Joel Solomon, Coral Gables, FL (US)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(73) Assignee: PRS, LLC

(21) Appl. No.: 11/361,721

(22) Filed: Feb. 24, 2006

Related U.S. Application Data
(60) Provisional application No. 60/656,026, filed on Feb. 24, 2005.

(51) Int. Cl. G06Q 40/00

(52) U.S. Cl. 705/38

(57) ABSTRACT

A method for entity risk management and for accumulating assets for a secure retirement is provided in which a non-MEC life insurance policy that is not considered a single premium insurance policy is purchased and funded over time by an owner of a business through proceeds from a loan made to the business in which the loan is secured by business assets that are then made subject to a UCC financing statement, thereby placing them beyond the reach of general creditors. Part of the loan may be immediately converted to certificates of deposit or other cash-equivalent assets and will be redeemed from time to time and distributed to the owner to pay the premiums on the non-MEC policy. Alternatively, the loan may be drawn against over time, and the draws will be distributed to the owner to pay the premiums. At retirement, the owner will receive some tax-free distributions from the non-MEC policy, as provided by the tax code then in effect, and distributions from the policy combined with other retirement income will provide secure income through the owner's retirement.

This filing is based upon provisional patent application No. 60/656.026, filed Feb. 24, 2005.

### BACKGROUND OF THE INVENTION

This invention provides a method for business owners and professionals (“Professional” or “Professionals”), such as doctors, lawyers, accountants, and the like, as well as manufacturers, and businesses of any type, to provide a secure income for and during an owner's retirement. One of the significant risks facing Professionals today is the likelihood that a client or former client may bring a malpractice or other legal action against the business or practice asserting a claim that the Professional has, somehow, acted or failed to act in a manner that has caused damage to the client. In addition, the business and its owners may be exposed to claims of creditors for events totally unrelated to the operation of the business, such that the Professional and business may become exposed to the claims of such potential future judgment creditors. For example, if a minor child of the Professional drives a car and causes a fatal car accident, the Professional and the business could become the targets of litigation seeking damages for the accident. History and experience have established that a significant proportion of legal actions against Professionals and their businesses lack substantial grounds, and many appear to be driven primarily by a desire to coerce a monetary settlement, rather than to recover for any actual wrongdoing. Nevertheless, because of the risk that a potentially catastrophic judgment against a Professional and the business could compromise the Professional's livelihood and retirement, planning to protect against the possibility that a legal action may be filed against the Professional and his or her business has become a standard factor for consideration in business risk management and retirement planning.

One method for insulating personal assets from exposure to litigation is for the Professional to provide services, either alone or together with other Professionals, through a corporation or other business entity, of which he or she is an owner. Such entities not only insulate their owners from claims directed against the business, but many business entities may qualify for favorable tax treatment under the United States Internal Revenue Code (“Tax Code”), the precise tax treatment being dependent upon the type of entity that is established. Examples of such entities are S corporations, C corporations, limited liability companies (LLCs) and limited liability partnerships (LLPs).

Another common vehicle for managing the risk of incurring a catastrophic judgment is the purchase of professional/business malpractice and liability insurance. Although, in the past, obtaining such insurance was both affordable and prudent, the escalating incidence of justified or unjustified litigation against Professionals and businesses for alleged malpractice or some other claim of wrongdoing has caused a commensurate escalation in the cost of obtaining and maintaining adequate levels of liability and malpractice insurance. Indeed, the high cost of obtaining and maintaining professional malpractice/liability insurance has reached crisis proportions in the United States, significantly reducing the profitability of businesses, and in some cases, causing some Professionals to leave a profession permanently. As a result of the alarmingly high rates being charged for insurance, many Professionals have made a considered decision to practice their respective professions without the adequate and reasonably priced protection offered by malpractice/liability insurance. The decision to practice without having insurance, however, leaves the Professional and his practice exposed to the vagaries of the legal system and the high costs of attempting to maneuver within it. In addition, exposure to claims can result in bankruptcy and ruin, even in cases in which the Professional is ultimately deemed not to be liable for the claimed injury. Alternatively, those businesses that can afford to maintain high levels of malpractice/liability insurances become targets for many potential claimants as a direct result of the opportunities resulting from the high levels of coverage and the opportunities for handsome settlements of claims against the business from their insurance carrier(s).

What is needed is a system through which a Professional's assets may be protected from exposure to exorbitant and frivolous legal claims during the Professional's career. Accordingly, it is an object of this invention to provide a system through which Professionals s can manage, deflect and withstand the risks of litigation without being exposed to the claims of potential future judgment creditors to their personal and business assets. Such claims open the business owner to potentially catastrophic judgments that would bankrupt their businesses and themselves personally. It is another object of the invention to provide business/entity risk management while continuing to have assets from the business be available to support and grow the business. It is another object of the invention to provide a secure and predictable retirement vehicle through which Professionals may extract portions of the appreciated value of their business during their working years and set aside such assets to aid in building sufficient financial assets to fund a secure and comfortable retirement. These and other objects of the invention will become apparent through the following description of the invention.

### SUMMARY OF THE INVENTION

Professional's companies are noteworthy for their relative lack of tangible assets and for the high earning power that is attributable to their owners' services. In addition, many companies may own tangible assets, but the equity portion of such assets is not working for the Professional as effectively as they could. As such, the primary assets of a business may be its accounts receivable, intellectual property and goodwill, although all assets that may be accepted as security for a loan would be acceptable (“Company Assets”). Other assets of a business that are dormant may include equity in real estate, inventory and equipment. These assets and others comprise the Company Assets used in the present invention. The present invention focuses upon a method of securing the Company Assets in a manner that dissuades litigation, places the assets beyond the reach of future judgment creditors while putting the value of up to 100% of the Company Assets to work for the benefit of the Professional to help create a more secure retirement for the Professional . This is achieved, in part, through a bank or other lending institution or lender (“the Lender”) lending the company an amount equal to up to 100% of the Company Assets. The loan will generally be secured by a pledge of the Company Assets and some of the Professional's personal assets. The loan and security are devised so that the cash flow of the successful company and personal lifestyle of the Professional are not impaired as a result of the loan, the loan interest amount or the security instruments for the loan. The Company Assets are shielded from exposure to litigation and general creditors through the Lender's filing of a Uniform Commercial Code (UCC) financing statement identifying the Company Assets being pledged to the Lender as collateral for repayment of the loan. Additional collateral for the loan is provided by the personal guarantees of the Professional and possibly by other assets identified below.

The method of this invention may be used where a number of Professionals have joined together to form a company having multiple owners, or where the company has but a single owner. Where there are multiple owners, the owners establish and follow a plan in order that Company Assets may be shielded from exposure to claims of future judgment creditors throughout the life of the plan. Although the terminology used in the following description of the invention is primarily directed toward a single owner of a company, it requires but minor adjustments to be applicable to multiple owners in a company, and is used in such a manner in such circumstances.

A Lender may lend up to 100% the value of a business because the loan will be secured by Company Assets, personal assets, and the personal guarantees of the Professionals . Such personal assets include certificates of deposit (CDs) purchased by the Company, the value of the Company Assets and other personal assets including but not limited to one or more insurance policies acceptable to the Lender. These assets, taken together, provide the bank with security that includes cash equivalent collateral equal to or exceeding 100% of the loan to the company. In many instances, the collateral in addition to the cash collateral described above may provide a first position in other non-cash collateral for some operating purpose of the business and the Lender lending under the program may be subordinate to such other creditors in a second secured position. Annual interest on the loan is paid over the life of the loan by the business and is generally paid under acceptable terms and conditions agreed to in advance under a fixed loan rate or under a formulaic varying loan rate.

Each distribution of the proceeds of the company loan to the Professional is reportable to the Federal and State Governments for tax purposes and is a taxable event to the extent the distribution is a not a return of capital. The taxable event is the distribution of some portion of the appreciated value of the business (in excess of the Professional's cost basis) and may result in a capital gains tax being payable by the Professional . Distributions will generally be made over a period of 5 years, with approximately 30-35% of the amount of the loan being immediately distributed to the Professionals and the remaining 70-65% being held by the corporation and placed into two CDs that may be offered by the lending bank that will mature, respectively, in one year and in four years. Approximately 30-35% of the money retained by the corporation will be placed in the one-year CD, with the remainder being placed into the four-year CD (some lenders will use only 1 CD with allowances to make penalty free withdrawals equal to the planned distributions). To the extent that the distribution exceeds the shareholder's basis in the stock of the business, taxes assessed on the immediate distribution will be paid from other personal funds of the Professional for the tax year of the distribution at long term capital gains rates. As CDs mature, their proceeds will be distributed to the Professional, and the Professional will pay taxes on each distribution in the year of the distribution.

Where the Professional 's basis in the business ownership interests is equal to or greater than the distributions, the Professional will pay no taxes. Regardless of the tax treatment on the distribution, the CDs will be purchased by the company and pledged to the bank as collateral to secure repayment of the loan to the company when loans in excess of the distributions exist.

The remainder of the money not placed in CDs may be used by the Professional to acquire any cash-equivalent collateral acceptable to the lender, such as money market funds, bank issued certificates of deposit, life insurance, or the like. Should the Professional acquire a life insurance policy and utilize the remainder of the money not placed in the CD's, the Professional may make a premium payment on a non-Modified Endowment (Life Insurance) Contract (“non-MEC”) that meets certain specifications. Such specifications include the development of cash surrender values that are acceptable to the Lender(s) in circumstances in which the Lender is collateralized by said policy(ies). The policy is owned by the Professional and may also be pledged as collateral for the loan to the company. Premiums for the non-MEC policy are paid over a period of years, rather than as a single payment, thereby allowing the policy to qualify for favorable tax treatment under the US Tax Code. After the policy has been in force for a number of years (generally more than 10), the life insurance policy and its cash surrender values may be used to provide a retirement income/supplemental income benefit through withdrawals and other distributions that are permitted (by the policy and the issuing insurance carrier and under the US Tax Code. Such withdrawals and distributions, up to the policy cost basis are generally not taxable to the policy owner. Additional funds can be extracted from the life insurance policy through policy loans against the policy cash value. Such cash extraction from the policy(ies) can be selected by the Professionals and policy owner(s) on a systematic or non-systematic basis. Such election is generally made in the future and need not be determined in advance or in the early stages of the program.

In an alternative embodiment, the invention will provide for a loan to the business in increments, similar to the increments distributed above, thereby nullifying the use of and need for CDs or some other instruments to be held by the company until such time as the portion of the appreciated value of the business is distributed to the Professional. In this embodiment, the loan will be drawn down in periodic incremental amounts, and the proceeds applied as is described for the preferred embodiment.

The present distribution of the loan proceeds anticipates that in most cases the distributions will occur in years 1, 2 and 5, although alternative time periods can be selected (e.g. years 1-5 consecutively). Generally, any taxation due and payable on the distributions will be made by the Professional from other cash sources. In addition to the loans and related distributions, the Professional(s) and policy owner(s) may elect to contribute (voluntary contributions) other finds to the policy(ies). The additional contributions to the policy increase the level of cash accumulation that becomes available for purposes of retirement and supplemental income. The source for such voluntary distributions may be other after tax dollars, paid into the policy(ies) on a regular or irregular basis, or may be the result of additional distributions the business elects to make, at points in time, to the Professional. By managing the life insurance policy to maintain a non-MEC status, tax treatment (under current US Tax Code) can be assured, and payments or distributions of the policy's cash value made after retirement will be tax-free.

Ongoing premium payments into the life insurance policy(ies) made by the Professional accrue and increase in value to the benefit of the policy(ies) owner. Such additional contributions/premiums can be designed to assure the Professional that the plan will be sufficiently funded to meet the Professional owner's future income goals. During the life of the loan, the business will make interest-only (generally, although some loans can allow for amortizing the principal during the loan period) loan payments to the Lender generally using income received from the ongoing business operations and income of the company. At the time the Professional retires, the company's accounts receivable may be collected over a period of time (often six months), other business assets may be sold or the entire company can be sold and the proceeds used to pay off the bank loan. If the sale of the business, sale of assets and/or collection of accounts receivable at retirement fully covers the outstanding loan balance, then the bank will release its collateral assignment in the policy and the Professional will own the life insurance policy without restrictions. The UCC financing statement will also be released at that time. If desired, the company may then be dissolved or liquidated. If the sale of such assets and collection of debt is not sufficient to fully pay off the Lender, other assets can be used to extinguish the loan, including portions of the cash value accumulated in the life insurance policy(ies). Depending on the tax status of the business and to the extent the Professional uses personal assets and contributes them to the business to help pay off the loan, such contribution might result in a capital loss inuring to the benefit of the Professional who may enjoy the tax benefits obtained under current US Tax Code.

Beginning at retirement, the life policy can make tax-free distributions to the now-retired Professional in amounts that, when aggregated with the Professional's social security or other outside income, meet the Professional's planned retirement goals for a predetermined length of time. During the period of payout from the life insurance policy, the remaining cash value will enjoy interest credits that will continue to accumulate tax-free and at such crediting rates generally favorable to rates for other comparable investment alternatives, and any distributions from the policy(ies) will be tax-free. In addition, if the professional should die before, or even after, the planned payout period, there will be an income tax free death benefit payable to the Professional's named beneficiary. These tax elements discussed are based upon US Tax Code.

### BRIEF DESCRIPTION OF THE DRAWINGS

FIG. 1 is a flow diagram showing steps in the process of this invention from inception of the plan through the retirement of the professional.

FIG. 2 is a chart showing representative values at various stages in the process.

FIG. 3 is a flow diagram showing steps in the process of this invention that begin upon the retirement of the professional.

FIG. 4 is a flow diagram of an alternative embodiment in which distributions to the Professional are made from periodic draws against the loan.

### DETAILED DESCRIPTION OF THE PREFERRED EMBODIMENTS

Although the process of this invention is suitable for business owners and professionals, and businesses of nearly any size, the following hypothetical example is based upon a retirement goal that satisfies the following parameters: A Professional begins the plan at age 45, and has an expected retirement age of 65. Upon retirement, and extending through at least the Professional's 80^{th} year, the Professional will receive a projected tax-free annual income of $271,000. A portion of the Professional's retirement income is projected to be provided by social security ($26,000), and the remainder ($245,000) will be funded through the life insurance policy that comprises part of this invention. The business is assumed to have Company Assets of $500,000 at the beginning of the plan and throughout the next twenty years until retirement. Although this example is used only for purposes of explanation and analogy, it is to be understood that it necessarily incorporates projections that may or may not reflect actual future conditions, and that such projections are subject to variations in the local and global economies, and in the tax laws relating to the subject matter of the invention. Despite such uncertainties, the process of this invention may beneficially be applied to fund retirement plans of larger or smaller size than that used in the example, and may be advantageously used in circumstances and situations other than the illustrations provided here.

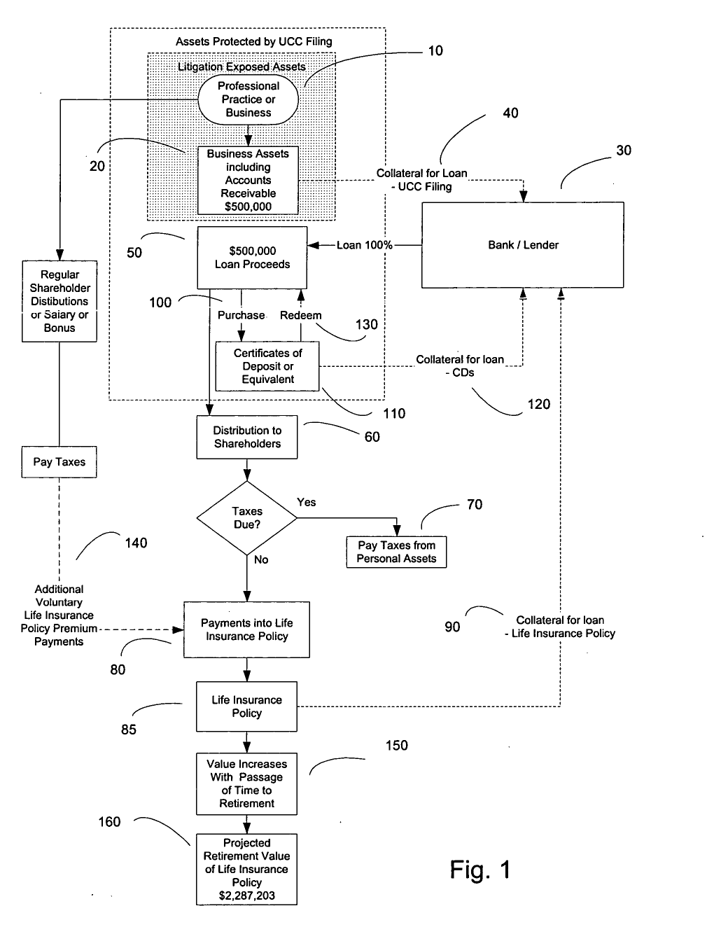

In FIG. 1, a Professional's business 10 having assets, including but not limited to accounts receivable 20 and goodwill, valued at $500,000, is exposed to the possible depletion of its assets through litigation, although the Professional is aware of no actual or pending litigation at the time the Professional puts the invention in place. The business will borrow up to 100% of the value of its assets from a lending institution 30, securing the loan with a UCC filing statement 40 that pledges all the assets of the business, including the accounts receivable, to the repayment of the loan. At this point, those assets of the company that are pledged to the repayment of the loan are protected from attachment or execution by future judgment creditors by virtue of the UCC filing statement. A portion of the loan proceeds 50 is used to make a distribution 60 to the owner. This distribution is equal to approximately 35% of the amount of the loan. The shareholder may take these finds and pay them as life insurance premium monies into a non-MEC (non-Modified Endowment Contract) life insurance policy 80, 85. If taxes are assessed on the distribution, they will be paid by the Professional's other personal funds upon such distribution 70. Typically, a shareholder in an S or C corporation will pay taxes upon a distribution to the extent that the distribution exceeds the shareholder's tax basis for the stock of the corporation. This distribution will generally be taxed at a federal capital gains rate that, under the present tax code, is 15% plus any applicable state and local taxes. If any capital gains and state and local taxes are due, it will be paid by the Professional with other personal funds. In the preferred embodiment depicted in FIG. 1, he loan 100 will be used by the company to purchase certificates of deposit (CDs) 110, which will be pledged to the bank as collateral for the loan 120. In this embodiment, a one-year CD and a four-year CD will be purchased. However, different combinations of CDs may be purchased, or a loan commitment may be drawn down over time, depending upon the desired yield curve (or no CDs as described earlier).

The Professional will use the distribution, generally about 35% of the loan or loan commitment, to make the payment on a non-MEC life insurance policy 80. The life insurance policy 85 will not be issued as a single premium life insurance policy, but will be a non-MEC that is funded over the years from its inception until retirement. The second and fifth years of premium payments will be funded from the redemption of the CDs 130, with additional after-tax voluntary personal premium payments 140 being made by the owner. During the second and third years, the only payments into the life insurance policy will be the voluntary personal premium payments 140 made by the owner. During the years remaining until retirement 150, the owner will continue to find the life insurance with annual voluntary personal premium payments 140. For the example given here, a monthly payment of $1,500 ($18,000 annually) made over a period of 15 years is adequate to fund the plan to reach the projected value 160 that will support the desired retirement distributions.

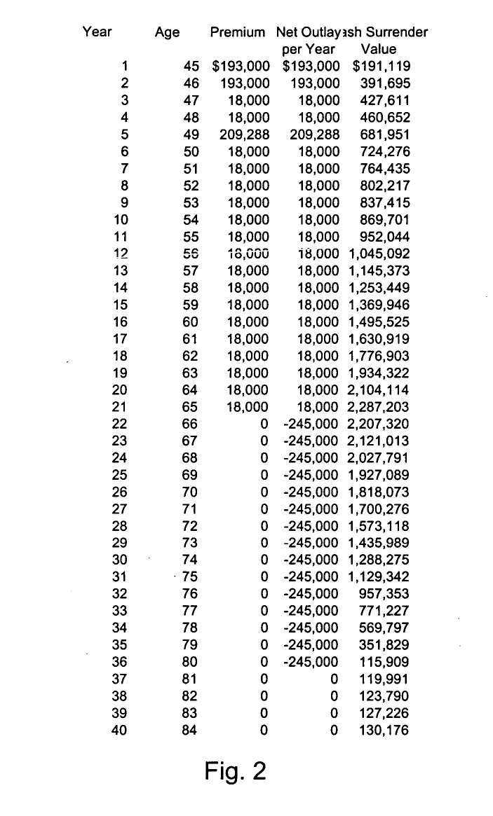

FIG. 2 is a chart showing the hypothetical accumulation of value in a life insurance policy based upon the example of a twenty year pay-in period prior to retirement and an annual projected tax-free payout of $245,000 (which, when aggregated with annual projected social security payments of $26,000 will total $271,000) per year for fifteen years following the date of retirement. In FIG. 2, the assumption is made that the company is an S corporation whose distributions to its shareholders generate a taxable event requiring tax payment on the gain in the year of distribution. As can be seen in FIG. 2, in each of years 1 and 2, a payment of $193,000 is made into the plan. This is based upon loan of $500,000, of which $175,000 is distributed to the shareholder to enable the shareholder to pay $175,000 into the policy along with a voluntary out-of-pocket contribution assumed to be at the rate of $1,500 per month or $18,000 annualized for a total of $193,000 paid into the policy(ies) during the first year. Following the distribution of $175,000 for the policy(ies), $325,000 will remain from the loan, and will be applied to the corporation's purchase of the two CDs. A one-year certificate of deposit is purchased for $166,905, and the remaining $158,095 will be used to purchase a four year certificate of deposit. In year 2, the 1-year certificate of deposit will have accrued to $175,000, based upon assumed CD yields provided by the financial institution, and will be redeemed and the proceeds distributed to the shareholder. The proceeds are distributed to the shareholder, and will subsequently be paid into the life insurance policy along with the shareholder's out-of-pocket contribution of $18,000, for a total payment into the policy during year 2 of $193,000. During the third and fourth years, payments of $18,000 are made into the policy each year from the shareholder's after-tax finds. In the fifth year, the four-year certificate of deposit will have accrued to $191,288, and will be redeemed, and its proceeds distributed to the shareholder, and will subsequently be paid, into the policy along with the shareholder's annual contribution of $18,000. Thereafter, voluntary annual payments of $18,000 will be made into the policy until the shareholder reaches age 65 and retires. At that point, as depicted in FIG. 2, the cash value of the policy is expected to have risen to $2,287,203 and there will be a death benefit of $2,744,643. In addition, the policy will qualify for tax-free distribution under Section 7702 of the Internal Revenue Code, and will be able to find payments of $245,000 to the policy's owner each year for the next 15 years.

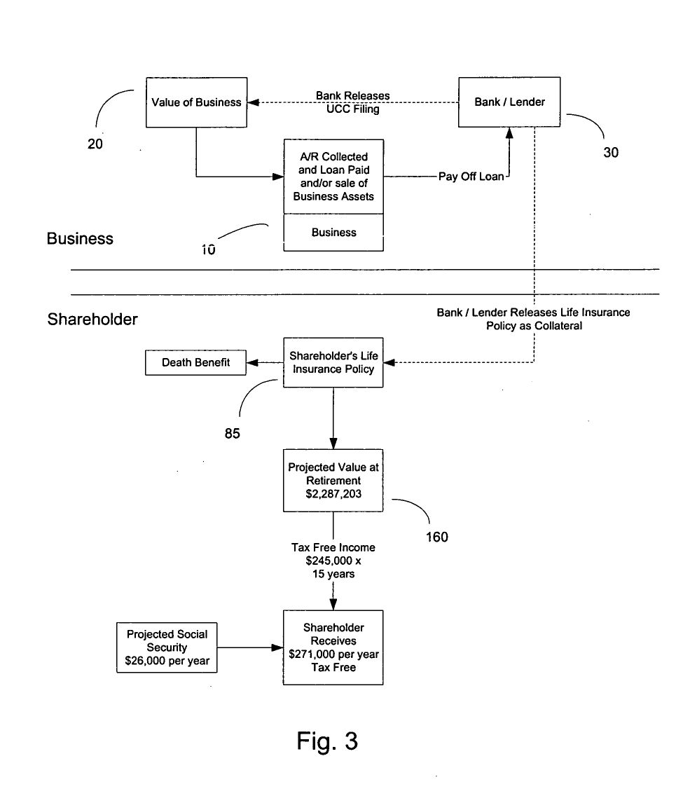

At retirement, as shown in FIG. 3, assuming that the life insurance policy will have appreciated under the current insurance company assumptions in the policy, including the insurance company's projections of the assumed interest crediting rate to the policy(ies), the cash surrender value of the life insurance policy(ies) 160 will be $2,287,203 twenty years after its inception. If the accounts receivable 20 and/or sales proceeds of the business remaining in the business in conjunction with any capital contributions made to the business by the shareholder 10 are sufficient to pay off the lender's loan, the collateral securing the loan will be released, and the shareholder will own the life insurance policy(ies) 85 without restrictions. Annual tax-free distributions of $245,000 can then be made to the shareholder for the next fifteen (15) years.

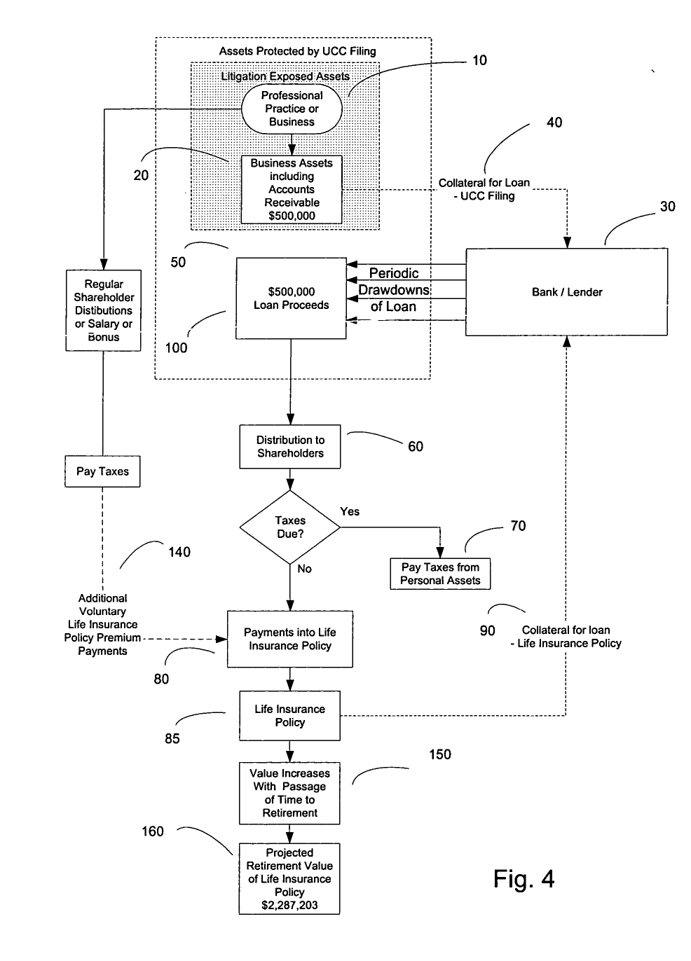

FIG. 4 is a flow chart depicting the method of an alternative embodiment of the invention. In FIG. 4, distributions are made to the shareholder from periodic draws against a loan for which the Lender has given a commitment. Rather than premium payments being financed through sales of a CD or other cash-equivalent investment by the business, as described in the preferred embodiment, premium payments are made from distributions made to the Professional by the business from subsequent draws against the loan by the business. The draws are then distributed to the Professional and used to pay the premium for the non-MEC policy in the same manner as distributions were made from redeemed CD's, as described with reference to FIG. 1.

Although the present invention has been described in relation to particular embodiments thereof, many other variations and other uses will be apparent to those skilled in the art. It is preferred, therefore, that the present invention be limited not by the specific disclosure herein, but only by the claims appurtenant hereto.

What is claimed is:

1. A method of providing income to an owner of a business comprising the steps of:
a business having assets;
said business obtaining a loan from a lender and granting a security interest in assets of said business as collateral for said loan;
said lender filing a Uniform Commercial Code (“UCC”) financing statement identifying said collateral as security to guarantee the repayment of said loan;
said business making payments on said loan, said payments being substantially applied to pay interest on said loan;
distributing a first portion of said loan to an owner of said business;
said owner purchasing a non-Modified Endowment Contract (“non-MEC”) of life insurance carrying a death benefit and having a premium payable over a term of not less than five years, said policy not being considered a single premium policy, said owner applying at least part of said first portion of said loan distributed to said owner to make a premium payment on said non-MEC policy;
said business applying a second portion of said loan to purchase a first certificate of deposit or comparable cash-equivalent investment (“CD”);
said business applying a third portion of said loan to purchase a second CD;
said business redeeming said first CD and distributing the proceeds from said first CD to said owner;
said owner applying said proceeds from said first CD to make a premium payment on said non-MEC policy;
said business redeeming said second CD and distributing the proceeds from said second CD to said owner;
said owner using said proceeds from said second CD to make a later premium payment on said non-MEC policy;
said owner making other premium payments on said non-MEC policy;
upon the occurrence of a predetermined event, said business paying off said loan;
said lender releasing said UCC financing statement;
said owner receiving distributions from said non-MEC policy.

2. A method of providing income to an owner of a business as claimed in claim 1, further comprising said first CD being a one-year certificate of deposit or comparable cash-equivalent investment and said second CD being a four-year certificate of deposit or comparable cash-equivalent investment.

3. A method of providing income to an owner of a business as claimed in claim 2, further comprising said first portion of said loan comprising approximately thirty-five percent (35%) of the total proceeds from said loan, said second portion of said loan comprising approximately twenty-three percent (23%) of the total proceeds from said loan, and said third portion comprising approximately forth-two percent (42%) of said loan.

4. A method of providing income to an owner of a business as claimed in claim 2, further comprising the step of increasing the value of said collateral by providing a security interest in said non-MEC policy to guarantee the repayment of said loan, and by providing a security interest in said first and second CDs to guarantee the repayment of said monetary loan.

5. A method of providing income to an owner of a business as claimed in claim 2, wherein said predetermined event constitutes the retirement of said owner.

6. A method of providing income to an owner of a business as claimed in claim 2, wherein said predetermined event constitutes the winding up of the affairs of said business.

7. A method of providing income to an owner of a business as claimed in claim 2, wherein, upon the occurrence of said predetermined event, said loan is paid at least in part from assets of said business.

8. A method of providing income to an owner of a business as claimed in claim 7, wherein at least a portion of said assets of said business comprise accounts receivable..

9. A method of providing income to an owner of a business as claimed in claim 2, wherein at least a portion of said second year and said fifth year premium payments on said non-MEC policy are made by applying proceeds distributed to said owner following the redemption of said first and said second CDs.

10. A method of providing income to an owner of a business as claimed in claim 2, further comprising said premium payments being made over a period of not less than four (4) years.

11. A method of providing income to an owner of a business as claimed in claim 1, wherein at least a portion of said distributions to said owner from said non-MEC policy comprise tax-free distributions.

12. A method of providing income to an owner of a business comprising the steps of:
a business obtaining a loan commitment from a lender and granting a security interest in assets of said business as collateral for the loan, said loan to be made in a series of discretionary draws against said loan commitment by said business over a period of time;
said lender filing a Uniform Commercial Code (“UCC”) financing statement identifying said collateral as security to guarantee the repayment of said loan;
said business making payments on said loan, said payments being substantially applied to pay interest on said loan;
said business making a first draw upon said loan and distributing at least a portion of said first draw to an owner of said business;
said owner purchasing a non-Modified Endowment Contract (“non-MEC”) of life insurance carrying a death benefit and having a premium payable over a term of not less than five years, said policy not being considered a single premium policy, said owner applying at least part of said first draw distributed to said owner to make a premium payment on said non-MEC policy;
said business receiving a second draw upon said loan and distributing at least a portion of said second draw to said owner;
said owner applying at least a portion of said second draw to make a premium payment on said non-MEC policy;
said business receiving a third draw upon said loan and distributing at least a portion of said third draw to said owner;
said owner applying at least a portion of said third draw to make a later premium payment on said non-MEC policy;
said owner making other premium payments on said non-MEC policy;
upon the occurrence of a predetermined event, said business paying off said loan;
said lender releasing said UCC financing statement;
said owner receiving distributions from said non-MEC policy.

13. A method of providing income to an owner of a business as claimed in claim 12 in which said second draw is used to pay said premium due at the end of the first year of said non-MEC policy, and said second draw is used to pay said premium due at the end of the fourth of said non-MEC policy.

14. A method of providing income to an owner of a business as claimed in claim 12, further comprising said first draw comprising approximately thirty-five percent (35%) of the total loan commitment, said second draw comprising approximately twenty-three percent (23%) of the total loan commitment, and said third draw comprising approximately forth-two percent (42%) of said total loan commitment.

15. A method of providing income to an owner of a business as claimed in claim 12, further comprising the step of increasing the value of said collateral by providing a security interest in said non-MEC policy to guarantee the repayment of said loan.

16. A method of providing income to an owner of a business as claimed in claim 12, wherein said predetermined event constitutes the retirement of said owner.

17. A method of providing income to an owner of a business as claimed in claim 12, wherein said predetermined event constitutes the winding up of the affairs of said business.

18. A method of providing income to an owner of a business as claimed in claim 12, wherein, upon the occurrence of said predetermined event, said loan is paid at least in part from assets of said business.

19. A method of providing income to an owner of a business as claimed in claim 12, further comprising said premium payments being made over a period of not less than four (4) years.

20. A method of providing income to an owner of a business as claimed in claim 12, wherein at least a portion of said distributions to said owner from said non-MEC policy comprise tax-free distributions.

21. A method of providing income to an owner of a business as claimed in claim 18, wherein at least a portion of said assets of said business comprise accounts receivable.
